(19) United States
(12) Patent Application Publication
(10) Pub. No.: US 2026/0265450 A1
(43) Pub. Date: Sep. 10, 2026

(54) COUPLING AGENTS

(71) Applicant: Lubrizol Advanced Materials, Inc., Cleveland, OH (US)

(72) Inventors: Robert A. Jennings, Manchester (GB); Andrew J. Shooter, Wilmslow (GB); Michael Collinge, Manchester (GB); Christopher Lowe, Manchester (GB); Dean Thetford, Rochdale (GB)

(73) Assignee: Lubrizol Advanced Materials, Inc., Cleveland, OH (US)

(21) Appl. No.: 18/871,914

(22) PCT Filed: Jun. 8, 2023
(86) PCT No.: PCT/US2023/024780

§ 371 Date: Dec. 5, 2024

Related U.S. Application Data
(60) Provisional application No. 63/350,646, filed on Jun. 9, 2022.

(51) Int. Cl. C08G 63/00; C08K 3/04; C08K 3/26; C08K 3/40

(52) U.S. Cl. CPC C08G 63/00; C08K 3/04; C08K 3/26; C08K 3/40; C08K 2003/265

(57) ABSTRACT

Disclosed are thermoset compositions including a dispersion of a particulate solid into a thermosetting resin in the presence of a coupling agent according to formula I described herein. Various methods of making and/or using the coupling agent and/or the thermoset compositions are also disclosed.

The disclosed technology relates to a polymer which may be used as a coupling agent, such as in thermoset compositions including particulate solids.

The incorporation of particulate solids (e.g., fillers and/or fibers) into polymeric materials (such as thermosetting polymers, thermoplastic polymers, elastomers, and/or rubber) is known; the combination of these materials represent a subset of composite material. Molded articles made from these types of composite materials may exhibit improved stiffness, hardness, and/or creep resistance, as compared with corresponding un-filled polymeric materials. However, these types of composite materials may exhibit a marked decrease in toughness and/or ductility, as compared with corresponding un-filled polymeric materials. In the cases of thermoplastic polymer and thermosetting polymers, composite molded articles may become too brittle, or too low in impact resistance and elongation to be of much practical use.

Various approaches have been attempted to improve compatibility of the particulate solid with the polymeric materials to improve such deficiencies. For example, incorporating a surface modifier or sizing agent, such as by coating the particulate solid, may improve compatibility. The surface modifier/sizing agent may generally fall within two categories: coupling agents and non-coupling modifiers. Non-coupling modifiers interact with the surface of the particulate solid, but do not interact with the polymer matrix.

Coupling agents interact with both the surface of the particulate solid and the polymer matrix. In many cases, coupling agents covalently bond to both the particulate solid and the polymer matrix. In other cases, an ion-pair interaction between the coupling agent and the particulate solid may be adequate, while chain entanglement and/or co-crystallization may provide a sufficient interaction between the coupling agent and the polymer matrix.

For example, acid-functional modifiers may be represented in both categories. Certain fatty acids may typically be considered non-coupling modifiers, where the carboxylic group binds to the surface of the particulate solid and the fatty group intercalates with the polymer matrix. Certain polymeric acids may generally be regarded as coupling agents, where the carboxy group interacts with the surface of the particulate solid, and the polymeric chain interacts with the polymer matrix. The extent of the interaction between the polymeric chain and the polymer matrix depends on the functionality of the polymeric chain and the type of polymeric material. Acrylic acid has been used as a coupling agent for calcium carbonate fillers in a polypropylene matrix, for example, but the volatility of acrylic acid during processing represents a distinct disadvantage.

Organosilanes are currently in use as coupling agents. Organosilanes contain alkoxy silane groups which may react with suitable hydroxyl groups on the surface of the particulate solid (for example, in the case of metal-hydroxide fillers, [metal]-O—Si covalent bonds are formed). The organosilane coupling agent also has another functional group which can react with the polymer matrix. A large range of commercially-available organosilane coupling agents are available to cope with surface hydroxyl groups of varying reactivities, and different reactions with the polymer chains in the matrix. Organosilanes can be quite effective, but they do have certain limitations. For instance, they may be relatively expensive because of the sophisticated chemical processing required, they may be ineffective for fillers which do not have surface hydroxyl groups, they may have limited compatibility with bulk polymer materials used (and thus may be applied as a surface treatment on the particulate solid, requiring additional process steps and/or limiting processing conditions), and they may release significant amounts of alcohols when reacting with certain particulate solids' surfaces.

The disclosed technology, therefore, provides polymers, useful as coupling agents, which may overcome certain deficiencies mentioned above.

The subject matter disclosed herein provides a polymer having monomeric units a, b, c, d, e, and f according to formula I.

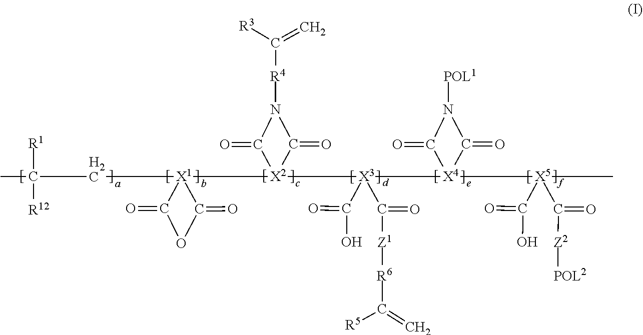

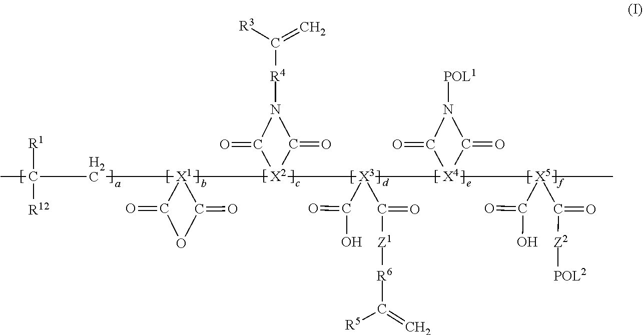

wherein, independently for each molecule of the polymer:
R¹ is H or CH₃;
R² is H, a C₁ to C₂₀ alkyl group, a C₆ to C₁₀ aryl group, a C₇ to C₁₄ alkaryl group, or a C₄ to C₆ cycloalkyl group;
X¹ is 2 or 3 carbon atoms, wherein if X¹ is 3 carbon atoms, one of the carbon atoms is not included in the polymer backbone;
X² is 2 or 3 carbon atoms, wherein if X² is 3 carbon atoms, one of the carbon atoms is not included in the polymer backbone;
R³ is H or CH₃;
R⁴ is a C₁ to C₂₀ alkyl group, —C—O—R⁷—, or —(C═O)—O—C—R⁷—, wherein R⁷ is a C₁ to C₂₀ alkyl group;
X³ is 2 or 3 carbon atoms, wherein if X³ is 3 carbon atoms, one of the carbon atoms is not included in the polymer backbone;
R⁵ is H or CH₃;
R⁶ is a C₁ to C₂₀ alkyl group, —C—O—R⁸—, or —(C═O)—O—C—R⁸—, wherein R⁸ is a C₁ to C₂₀ alkyl group;
Z¹ is NH or O;
X⁴ is 2 or 3 carbon atoms, wherein if X⁴ is 3 carbon atoms, one of the carbon atoms is not included in the polymer backbone;
POL¹ is a polymer comprising at least one of a polyether or a polyester, wherein the polymer has a theoretical-number-average molecular weight of from 200 to 3,000;
X⁵ is 2 or 3 carbon atoms, wherein if X⁵ is 3 carbon atoms, one of the carbon atoms is not included in the polymer backbone;
POL² is a polymer comprising at least one of a polyether or a polyester, wherein the polymer has a theoretical-number-average molecular weight of from 200 to 3,000;
Z² is NH or O;
a is an integer from 1 to 500;
b is an integer from 1 to 500;
c is 0, or an integer from 1 to 100;
d is 0, or an integer from 1 to 100;
e is 0, or an integer from 1 to 100; and
f is 0 or an integer from 1 to 100;
wherein: if c is 0, d is at least 1; if d is 0, c is at least 1; if e is 0, f is at least 1; and if f is 0, e is at least 1.

In certain embodiments, the polymer may be used as a coupling agent in a thermoset composition. For example, a thermoset composition may comprise a dispersion of a particulate solid into a thermosetting resin in the presence of the coupling agent.

Also provided are various methods of making and/or using the polymer, the coupling agent, and/or the thermoset composition.

The following embodiments of the present subject matter are contemplated:

1. A thermoset composition comprising a dispersion of a particulate solid into a thermosetting resin in the presence of a coupling agent comprising monomeric units a, b, c, d, e, and f according to formula I:

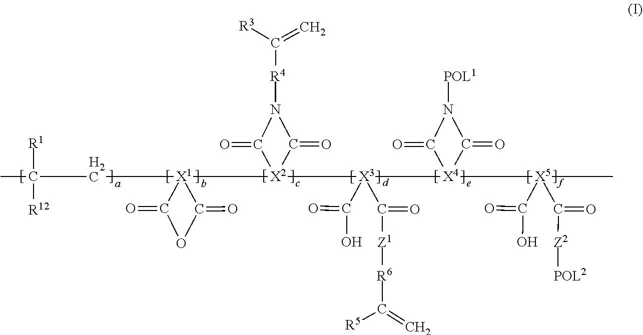

wherein, independently for each molecule of the polymer:
R¹ is H or CH₃;
R² is H, a C₁ to C₂₀ alkyl group, a C₆ to C₁₀ aryl group, a C₇ to C₁₄ alkaryl group, or a C₄ to C₆ cycloalkyl group;
X¹ is 2 or 3 carbon atoms, wherein if X¹ is 3 carbon atoms, one of the carbon atoms is not included in the polymer backbone;
X² is 2 or 3 carbon atoms, wherein if X² is 3 carbon atoms, one of the carbon atoms is not included in the polymer backbone;
R³ is H or CH₃;
R⁴ is a C₁ to C₂₀ alkyl group, —C—O—R⁷—, or —(C═O)—O—C—R⁷—, wherein R⁷ is a C₁ to C₂₀ alkyl group;
X³ is 2 or 3 carbon atoms, wherein if X³ is 3 carbon atoms, one of the carbon atoms is not included in the polymer backbone;
R⁵ is H or CH₃;
R⁶ is a C₁ to C₂₀ alkyl group, —C—O—R⁸—, or —(C═O)—O—C—R⁸—, wherein R⁸ is a C₁ to C₂₀ alkyl group;
Z¹ is NH or O;
X⁴ is 2 or 3 carbon atoms, wherein if X⁴ is 3 carbon atoms, one of the carbon atoms is not included in the polymer backbone;
POL¹ is a polymer comprising at least one of a polyether or a polyester, wherein the polymer has a theoretical-number-average molecular weight of from 200 to 3,000;
X⁵ is 2 or 3 carbon atoms, wherein if X⁵ is 3 carbon atoms, one of the carbon atoms is not included in the polymer backbone;
POL² is a polymer comprising at least one of a polyether or a polyester, wherein the polymer has a theoretical-number-average molecular weight of from 200 to 3,000;
Z² is NH or O;
a is an integer from 1 to 500;
b is an integer from 1 to 500;
c is 0, or an integer from 1 to 100;
d is 0, or an integer from 1 to 100;
e is 0, or an integer from 1 to 100; and
f is 0 or an integer from 1 to 100;
wherein: if c is 0, d is at least 1; if d is 0, c is at least 1; if e is 0, f is at least 1; and if f is 0, e is at least 1.

2. The thermoset composition of embodiment 1, wherein the particulate solid is present in an amount of from 20 to 80 weight percent, based on the total weight of the thermoset composition.

3. The thermoset composition of either embodiment 1 or embodiment 2, wherein the particulate solid comprises at least one of an extender, a reinforcing material, or a functional filler.

4. The thermoset composition of embodiment 3, wherein the extender comprises at least one of calcium carbonate, talc, barium sulfate, alumina, or quartz.

5. The thermoset composition of either embodiment 3 or embodiment 4, wherein the reinforcing material comprises at least one type of fibrous material.

6. The thermoset composition of any one of embodiments 3 to 5, wherein the functional filler comprises at least one of flame retardant materials or pigments.

7. The thermoset composition of any one of embodiments 1 to 6, wherein the thermosetting resin is present in an amount of from 80 to 20 weight percent, based on the total weight of the thermoset composition.

8. The thermoset composition of any one of embodiments 1 to 7, wherein the thermosetting resin comprises an epoxide resin, an unsaturated polyester resin, a vinyl ester resin, a polyurethane resin, or a phenolic resin.

9. The thermoset composition of any one of embodiments 1 to 8, wherein the coupling agent is present in an amount of from 0.5 to 5 weight percent, based on the total weight of the thermoset composition.

10. The thermoset composition of any one of embodiments 1 to 9, wherein the coupling agent comprises at least 90 percent by weight monomeric units a, b, c, d, e, and f, according to formula I, based on the total weight of the coupling agent.

11. The thermoset composition of any one of embodiments 1 to 10, wherein the coupling agent comprises at least 70 percent by weight monomeric units a and b, according to formula I, based on the total weight of the coupling agent.

12. The thermoset composition of any one of embodiments 1 to 11, wherein the coupling agent comprises no more than 30 percent by weight monomeric units c, d, e, and f, according to formula I, based on the total weight of the coupling agent.

13. The thermoset composition of any one of embodiments 1 to 12, wherein the coupling agent comprises at least 50 percent by weight monomeric units a, according to formula I, based on the total weight of the coupling agent.

14. The thermoset composition of any one of embodiments 1 to 13, wherein the coupling agent comprises no more than 40 percent by weight monomeric units b, according to formula I, based on the total weight of the coupling agent.

15. The thermoset composition of any one of embodiments 1 to 14, wherein a is an integer from 5 to 500.

16. The thermoset composition of any one of embodiments 1 to 15, wherein a is an integer from 20 to 50.

17. The thermoset composition of any one of embodiments 1 to 16, wherein b is an integer from 2 to 100.

18. The thermoset composition of any one of embodiments 1 to 17, wherein b is an integer from 3 to 12.

19. The thermoset composition of any one of embodiments 1 to 18, wherein the ratio of a to b is from 1:1 to 10:1.

20. The thermoset composition of any one of embodiments 1 to 19, wherein c is an integer from 3 to 12.

21. The thermoset composition of any one of embodiments 1 to 20, wherein d is an integer from 3 to 12.

22. The thermoset composition of any one of embodiments 1 to 21, wherein e is an integer from 4 to 16.

23. The thermoset composition of any one of embodiments 1 to 22, wherein f is an integer from 4 to 16.

24. The thermoset composition of any one of embodiments 1 to 23, wherein the coupling agent comprises up to 10 percent by weight other monomeric units, different from monomeric units a, b, c, d, e, and f, according to formula I.

Various features and embodiments of the present subject matter will be described below by way of non-limiting illustration.

As used herein, the indefinite article “a”/“an” is intended to mean one or more than one. As used herein, the phrase “at least one” means one or more than one of the following terms. Thus, “a”/“an” and “at least one” may be used interchangeably. For example “at least one of A, B or C” means that just one of A, B or C may be included, and any mixture of two or more of A, B and C may be included, in alternative embodiments.

As used herein, the term “substantially” means that a value of a given quantity is within +10% of the stated value. In other embodiments, the value is within +5% of the stated value. In other embodiments, the value is within +2.5% of the stated value. In other embodiments, the value is within +1% of the stated value.

As used herein, the transitional term “comprising,” which is synonymous with “including,” “containing,” or “characterized by,” is inclusive or open-ended and does not exclude additional, un-recited elements or method steps. However, in each recitation of “comprising” herein, it is intended that the term also encompass, as alternative embodiments, the phrases “consisting essentially of” and “consisting of,” where “consisting of” excludes any element or step not specified and “consisting essentially of” permits the inclusion of additional un-recited elements or steps that do not materially affect the essential or basic and novel characteristics of the composition or method under consideration.

Provided is a thermoset composition comprising a dispersion of a particulate solid into a thermosetting resin in the presence of a coupling agent comprising monomeric units a, b, c, d, e, and f according to formula I:

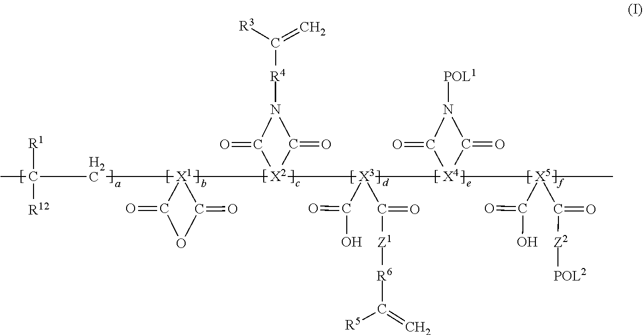

wherein, independently for each molecule of the polymer:
R¹ is H or CH₃;
R² is H, a C₁ to C₂₀ alkyl group, a C₆ to C₁₀ aryl group, a C₇ to C₁₄ alkaryl group, or a C₄ to C₆ cycloalkyl group;
X¹ is 2 or 3 carbon atoms, wherein if X¹ is 3 carbon atoms, one of the carbon atoms is not included in the polymer backbone;
X² is 2 or 3 carbon atoms, wherein if X² is 3 carbon atoms, one of the carbon atoms is not included in the polymer backbone;
R³ is H or CH₃;
R⁴ is a C₁ to C₂₀ alkyl group, —C—O—R⁷—, or —(C═O)—O—C—R⁷—, wherein R⁷ is a C₁ to C₂₀ alkyl group;
X³ is 2 or 3 carbon atoms, wherein if X³ is 3 carbon atoms, one of the carbon atoms is not included in the polymer backbone;
R⁵ is H or CH₃;
R⁶ is a C₁ to C₂₀ alkyl group, —C—O—R⁸—, or —(C═O)—O—C—R⁸—, wherein R⁸ is a C₁ to C₂₀ alkyl group;
Z¹ is NH or O;
X⁴ is 2 or 3 carbon atoms, wherein if X⁴ is 3 carbon atoms, one of the carbon atoms is not included in the polymer backbone;
POL¹ is a polymer comprising at least one of a polyether or a polyester, wherein the polymer has a theoretical-number-average molecular weight of from 200 to 3,000 (such as from 250 to 3,000, from 300 to 3,000, from 350 to 3,000, from 400 to 3,000, from 450 to 3,000, from 500 to 3,000, from 600 to 3,000, from 700 to 3,000, from 800 to 3,000, from 900 to 3,000, from 1,000 to 3,000, from 1,200 to 3,000, from 1,400 to 3,000, from 1,600 to 3,000, from 1,800 to 3,000, from 2,000 to 3,000, from 2,500 to 3,000, from 200 to 2,500, from 250 to 2,500, from 300 to 2,500, from 350 to 2,500, from 400 to 2,500, from 450 to 2,500, from 500 to 2,500, from 600 to 2,500, from 700 to 2,500, from 800 to 2,500, from 900 to 2,500, from 1,000 to 2,500, from 1,200 to 2,500, from 1,400 to 2,500, from 1,600 to 2,500, from 1,800 to 2,500, from 2,000 to 2,500, from 200 to 2,000, from 250 to 2,000, from 300 to 2,000, from 350 to 2,000, from 400 to 2,000, from 450 to 2,000, from 500 to 2,000, from 600 to 2,000, from 700 to 2,000, from 800 to 2,000, from 900 to 2,000, from 1,000 to 2,000, from 1,200 to 2,000, from 1,400 to 2,000, from 1,600 to 2,000, from 1,800 to 2,000, from 200 to 1,800, from 250 to 1,800, from 300 to 1,800, from 350 to 1,800, from 400 to 1,800, from 450 to 1,800, from 500 to 1,800, from 600 to 1,800, from 700 to 1,800, from 800 to 1,800, from 900 to 1,800, from 1,000 to 1,800, from 1,200 to 1,800, from 1,400 to 1,800, from 1,600 to 1,800, from 200 to 1,600, from 250 to 1,600, from 300 to 1,600, from 350 to 1,600, from 400 to 1,600, from 450 to 1,600, from 500 to 1,600, from 600 to 1,600, from 700 to 1,600, from 800 to 1,600, from 900 to 1,600, from 1,000 to 1,600, from 1,200 to 1,600, from 1,400 to 1,600, from 200 to 1,400, from 250 to 1,400, from 300 to 1,400, from 350 to 1,400, from 400 to 1,400, from 450 to 1,400, from 500 to 1,400, from 600 to 1,400, from 700 to 1,400, from 800 to 1,400, from 900 to 1,400, from 1,000 to 1,400, from 1,200 to 1,400, from 200 to 1,200, from 250 to 1,200, from 300 to 1,200, from 350 to 1,200, from 400 to 1,200, from 450 to 1,200, from 500 to 1,200, from 600 to 1,200, from 700 to 1,200, from 800 to 1,200, from 900 to 1,200, from 1,000 to 1,200, from 200 to 1,000, from 250 to 1,000, from 300 to 1,000, from 350 to 1,000, from 400 to 1,000, from 450 to 1,000, from 500 to 1,000, from 600 to 1,000, from 700 to 1,000, from 800 to 1,000, from 900 to 1,000, from 200 to 900, from 250 to 900, from 300 to 900, from 350 to 900, from 400 to 900, from 450 to 900, from 500 to 900, from 600 to 900, from 700 to 900, from 800 to 900, from 200 to 800, from 250 to 800, from 300 to 800, from 350 to 800, from 400 to 800, from 450 to 800, from 500 to 800, from 600 to 800, from 700 to 800, from 200 to 700, from 250 to 700, from 300 to 700, from 350 to 700, from 400 to 700, from 450 to 700, from 500 to 700, from 600 to 700, from 200 to 600, from 250 to 600, from 300 to 600, from 350 to 600, from 400 to 600, from 450 to 600, from 500 to 600, from 200 to 500, from 250 to 500, from 300 to 500, from 350 to 500, from 400 to 500, or from 450 to 500);
X⁵ is 2 or 3 carbon atoms, wherein if X⁵ is 3 carbon atoms, one of the carbon atoms is not included in the polymer backbone;
POL² is a polymer comprising at least one of a polyether or a polyester, wherein the polymer has a theoretical-number-average molecular weight of from 200 to 3,000 (such as from 250 to 3,000, from 300 to 3,000, from 350 to 3,000, from 400 to 3,000, from 450 to 3,000, from 500 to 3,000, from 600 to 3,000, from 700 to 3,000, from 800 to 3,000, from 900 to 3,000, from 1,000 to 3,000, from 1,200 to 3,000, from 1,400 to 3,000, from 1,600 to 3,000, from 1,800 to 3,000, from 2,000 to 3,000, from 2,500 to 3,000, from 200 to 2,500, from 250 to 2,500, from 300 to 2,500, from 350 to 2,500, from 400 to 2,500, from 450 to 2,500, from 500 to 2,500, from 600 to 2,500, from 700 to 2,500, from 800 to 2,500, from 900 to 2,500, from 1,000 to 2,500, from 1,200 to 2,500, from 1,400 to 2,500, from 1,600 to 2,500, from 1,800 to 2,500, from 2,000 to 2,500, from 200 to 2,000, from 250 to 2,000, from 300 to 2,000, from 350 to 2,000, from 400 to 2,000, from 450 to 2,000, from 500 to 2,000, from 600 to 2,000, from 700 to 2,000, from 800 to 2,000, from 900 to 2,000, from 1,000 to 2,000, from 1,200 to 2,000, from 1,400 to 2,000, from 1,600 to 2,000, from 1,800 to 2,000, from 200 to 1,800, from 250 to 1,800, from 300 to 1,800, from 350 to 1,800, from 400 to 1,800, from 450 to 1,800, from 500 to 1,800, from 600 to 1,800, from 700 to 1,800, from 800 to 1,800, from 900 to 1,800, from 1,000 to 1,800, from 1,200 to 1,800, from 1,400 to 1,800, from 1,600 to 1,800, from 200 to 1,600, from 250 to 1,600, from 300 to 1,600, from 350 to 1,600, from 400 to 1,600, from 450 to 1,600, from 500 to 1,600, from 600 to 1,600, from 700 to 1,600, from 800 to 1,600, from 900 to 1,600, from 1,000 to 1,600, from 1,200 to 1,600, from 1,400 to 1,600, from 200 to 1,400, from 250 to 1,400, from 300 to 1,400, from 350 to 1,400, from 400 to 1,400, from 450 to 1,400, from 500 to 1,400, from 600 to 1,400, from 700 to 1,400, from 800 to 1,400, from 900 to 1,400, from 1,000 to 1,400, from 1,200 to 1,400, from 200 to 1,200, from 250 to 1,200, from 300 to 1,200, from 350 to 1,200, from 400 to 1,200, from 450 to 1,200, from 500 to 1,200, from 600 to 1,200, from 700 to 1,200, from 800 to 1,200, from 900 to 1,200, from 1,000 to 1,200, from 200 to 1,000, from 250 to 1,000, from 300 to 1,000, from 350 to 1,000, from 400 to 1,000, from 450 to 1,000, from 500 to 1,000, from 600 to 1,000, from 700 to 1,000, from 800 to 1,000, from 900 to 1,000, from 200 to 900, from 250 to 900, from 300 to 900, from 350 to 900, from 400 to 900, from 450 to 900, from 500 to 900, from 600 to 900, from 700 to 900, from 800 to 900, from 200 to 800, from 250 to 800, from 300 to 800, from 350 to 800, from 400 to 800, from 450 to 800, from 500 to 800, from 600 to 800, from 700 to 800, from 200 to 700, from 250 to 700, from 300 to 700, from 350 to 700, from 400 to 700, from 450 to 700, from 500 to 700, from 600 to 700, from 200 to 600, from 250 to 600, from 300 to 600, from 350 to 600, from 400 to 600, from 450 to 600, from 500 to 600, from 200 to 500, from 250 to 500, from 300 to 500, from 350 to 500, from 400 to 500, or from 450 to 500);
Z² is NH or O;
a is an integer from 1 to 500;
b is an integer from 1 to 500;
c is 0, or an integer from 1 to 100;
d is 0, or an integer from 1 to 100;
e is 0, or an integer from 1 to 100; and
f is 0 or an integer from 1 to 100;
wherein: if c is 0, d is at least 1; if d is 0, c is at least 1; if e is 0, f is at least 1; and if f is 0, e is at least 1.

The phrase “comprising monomeric units a, b, c, d, e, and f according to formula I” should be understood to mean simply that the monomeric units are present (or optionally not present, as in the case of monomeric units c, d, e, and f) as set forth in the variable definitions provided for formula I, and also that it is possible that other monomeric units, different from monomeric units a, b, c, d, e, and/or f, may be included; the phrase is not intended to mean that all of the monomeric units must be present, or that other monomeric units are excluded. Further, it should be understood that the monomeric units may (perhaps likely will) be included in any order, such as a random order, rather than being present in the order shown in formula I (although it is theoretically possible that the monomeric units could be present in a block-copolymer-type structure, either in the order shown in formula I or in any other order). In practice, it may be difficult to control the placement of each monomeric unit relative to any other monomeric unit, which generally will result in a random structure; however, it is possible to control the number of units of each monomeric unit present, as would be understood by those of skill in the relevant art.

By “theoretical-number-average molecular weight”, what is meant is the average molecular weight of the subject group of bonded atoms determined by summing the molecular weight of each atom of the group based on its chemical formula.

With regard to the when any of the variables X¹, X², X³, X⁴, and X⁵, may represent 3 carbon atoms, the phrase “not included in the polymer backbone” means that one of the 3 carbon atoms is not in line with the other atoms present in the polymer backbone, but rather is associated with the pendant group attached to the backbone. For example, to illustrate this concept, each of X¹, X², X³, X⁴, and X⁵ may be derived from (without limitation) maleic anhydride or itaconic anhydride. If derived from maleic anhydride, the respective X¹, X², X³, X⁴, or X⁵ variable represent 2 carbon atoms, and the relevant portion of the polymer would appear as follows:

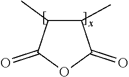

If derived from itaconic anhydride, the respective X¹, X², X³, X⁴, or X⁵ variable would represent 3 carbon atoms, and the relevant portion of the polymer would appear as follows:

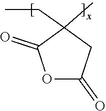

In certain embodiments, the particulate solid is present in an amount of from 20 to 80 (such as from 25 to 80, from 30 to 80, from 35 to 80, from 40 to 80, from 45 to 80, from 50 to 80, from 55 to 80, from 60 to 80, from 65 to 80, from 70 to 80, from 75 to 80, from 20 to 75, from 25 to 75, from 30 to 75, from 35 to 75, from 40 to 75, from 45 to 75, from 50 to 75, from 55 to 75, from 60 to 75, from 65 to 75, from 70 to 75, from 20 to 70, from 25 to 70, from 30 to 70, from 35 to 70, from 40 to 70, from 45 to 70, from 50 to 70, from 55 to 70, from 60 to 70, from 65 to 70, from 20 to 65, from 25 to 65, from 30 to 65, from 35 to 65, from 40 to 65, from 45 to 65, from 50 to 65, from 55 to 65, from 60 to 65, from 20 to 60, from 25 to 60, from 30 to 60, from 35 to 60, from 40 to 60, from 45 to 60, from 50 to 60, from 55 to 60, from 20 to 55, from 25 to 55, from 30 to 55, from 35 to 55, from 40 to 55, from 45 to 55, from 50 to 55, from 20 to 50, from 25 to 50, from 30 to 50, from 35 to 50, from 40 to 50, from 45 to 50, from 20 to 45, from 25 to 45, from 30 to 45, from 35 to 45, from 40 to 45, from 20 to 40, from 25 to 40, from 30 to 40, from 35 to 40, from 20 to 35, from 25 to 35, from 30 to 35, from 20 to 30, from 25 to 30, or from 20 to 25) weight percent, based on the total weight of the thermoset composition. The particulate solid may be any solid material suitable for incorporation into a thermosetting resin, such as to create a composite material. Particulate solids of varying densities may be included in thermosetting resins, depending on the intended use of the resulting composition and/or the desired properties of the resulting composition. As such, the percent by weight of the particulate solid present in the composition may vary widely based upon both the density and the amount of particulate solid present.

In certain embodiments, the particulate solid is present in an amount of from 20 to 80 (such as from 25 to 80, from 30 to 80, from 35 to 80, from 40 to 80, from 45 to 80, from 50 to 80, from 55 to 80, from 60 to 80, from 65 to 80, from 70 to 80, from 75 to 80, from 20 to 75, from 25 to 75, from 30 to 75, from 35 to 75, from 40 to 75, from 45 to 75, from 50 to 75, from 55 to 75, from 60 to 75, from 65 to 75, from 70 to 75, from 20 to 70, from 25 to 70, from 30 to 70, from 35 to 70, from 40 to 70, from 45 to 70, from 50 to 70, from 55 to 70, from 60 to 70, from 65 to 70, from 20 to 65, from 25 to 65, from 30 to 65, from 35 to 65, from 40 to 65, from 45 to 65, from 50 to 65, from 55 to 65, from 60 to 65, from 20 to 60, from 25 to 60, from 30 to 60, from 35 to 60, from 40 to 60, from 45 to 60, from 50 to 60, from 55 to 60, from 20 to 55, from 25 to 55, from 30 to 55, from 35 to 55, from 40 to 55, from 45 to 55, from 50 to 55, from 20 to 50, from 25 to 50, from 30 to 50, from 35 to 50, from 40 to 50, from 45 to 50, from 20 to 45, from 25 to 45, from 30 to 45, from 35 to 45, from 40 to 45, from 20 to 40, from 25 to 40, from 30 to 40, from 35 to 40, from 20 to 35, from 25 to 35, from 30 to 35, from 20 to 30, from 25 to 30, or from 20 to 25) volume percent, based on the total volume of the thermoset composition.

In certain embodiments, the particulate solid comprises at least one of an extender, a reinforcing material, or a functional filler. Extenders, sometimes referred to as fillers, are generally known to be materials which are included primarily to reduce the cost of the composition without adversely affecting its properties, as they are generally less costly than other ingredients of the composition. In certain embodiments, the extender comprises at least one of calcium carbonate, talc, barium sulfate, alumina, or quartz. Suitable extenders include, but are not limited to: wollastonite (including surface-treated wollastonite); calcium sulfate (as its anhydride, dihydrate or trihydrate); calcium carbonate (including chalk); limestone, marble and synthetic, precipitated calcium carbonates, generally in the form of a ground particulate which often comprises 98+% CaCO₃ with the remainder being other inorganics such as magnesium carbonate, iron oxide, and alumino-silicates; surface-treated calcium carbonates; talc, including fibrous, modular, needle shaped, and lamellar talc; glass spheres, both hollow and solid; and kaolin, including hard, soft, calcined kaolin, and kaolin comprising various coatings known to the art to facilitate the dispersion in and compatibility with the thermoset resin; mica; feldspar and nepheline syenite; silicate spheres; flue dust; cenospheres; fillite; aluminosilicate (armospheres); natural silica sand; quartz; quartzite; perlite; Tripoli; diatomaceous earth; synthetic silica, and the like.

Functional fillers are generally known to be materials which are included primarily to provide and/or improve certain properties of the composition, such as fire/flame retardant materials and/or pigments. In certain embodiments, the functional filler comprises at least one of flame retardant materials or pigments. Suitable functional fillers may include, but are not limited to: boron-nitride powder and boron-silicate powders for obtaining cured products having low dielectric constant and low dielectric loss tangent; or silica powder (such as fused silica and/or crystalline silica), alumina, and/or magnesium oxide (or magnesia) for high temperature conductivity.

In certain embodiments, the extenders and/or functional fillers may comprise particles having an average aspect ratio less than about 5:1.

Reinforcing materials are generally known to be materials which are included primarily to increase certain physical properties of the composition, such as tensile strength. In certain embodiments, the reinforcing material comprises at least one type of fibrous material. As used herein, the term “fibrous material” is intended to mean any material of which each particle generally has a length (the longest dimension of each particle of the material, perhaps taken on average) substantially longer than its width (the shortest dimension of each particle the material, perhaps taken on average), such as a ratio of the length to the width of greater than about 5:1, perhaps taken on average. Suitable fibers may include, but are not limited to, fibers having a high tensile strength (such as greater than 500 kpsi (or 3447 MPa)), carbon or graphite fibers, glass fibers and fibers formed of silicon carbide, alumina, boron, quartz, and the like, as well as fibers formed from organic polymers, such as for example polyolefins, poly(benzothiazole), poly(benzimidazole), polyarylates, poly(benzoxazole), aromatic polyamides, polyaryl ethers and the like, and may include mixtures having two or more such fibers. The fibers may be used in the form of discontinuous or continuous tows made up of multiple filaments, as continuous unidirectional or multidirectional tapes, as chopped loose fibers, or as woven, noncrimped, or nonwoven fabrics. The woven form may be selected from plain, satin, or twill weave style. The noncrimped fabric may have a number of plies and fiber orientations.

In certain embodiments, the thermosetting resin is present in an amount of from 80 to 20 (such as from 75 to 20, from 70 to 20, from 65 to 20, from 60 to 20, from 55 to 20, from 50 to 20, from 45 to 20, from 40 to 20, from 35 to 20, from 30 to 20, from 25 to 20, from 80 to 25, from 75 to 25, from 70 to 25, from 65 to 25, from 60 to 25, from 55 to 25, from 50 to 25, from 45 to 25, from 40 to 25, from 35 to 25, from 30 to 25, from 80 to 30, from 75 to 30, from 70 to 30, from 65 to 30, from 60 to 30, from 55 to 30, from 50 to 30, from 45 to 30, from 40 to 30, from 35 to 30, from 80 to 35, from 75 to 35, from 70 to 35, from 65 to 35, from 60 to 35, from 55 to 35, from 50 to 35, from 45 to 35, from 40 to 35, from 80 to 40, from 75 to 40, from 70 to 40, from 65 to 40, from 60 to 40, from 55 to 40, from 50 to 40, from 45 to 40, from 80 to 45, from 75 to 45, from 70 to 45, from 65 to 45, from 60 to 45, from 55 to 45, from 50 to 45, from 80 to 50, from 75 to 50, from 70 to 50, from 65 to 50, from 60 to 50, from 55 to 50, from 80 to 50, from 75 to 50, from 70 to 50, from 65 to 50, from 60 to 50, from 80 to 55, from 75 to 55, from 70 to 55, from 65 to 55, from 60 to 55, from 80 to 60, from 75 to 60, from 70 to 60, from 65 to 60, from 80 to 65, from 75 to 65, from 70 to 65, from 80 to 70, from 75 to 70, or from 80 to 75) weight percent, based on the total weight of the thermoset composition.

In certain embodiments, the thermosetting resin comprises an epoxide resin, an unsaturated polyester resin, a vinyl ester resin, a polyurethane resin, or a phenolic resin. Suitable thermosetting resins include resins which undergo a chemical reaction when heated, catalysed, or subject to ultra-violet, laser light, infra-red, cationic, electron beam, or microwave radiation and become relatively infusible. Illustrative reactions in thermosetting resins include oxidation of unsaturated double bonds, reactions involving epoxy/amine, epoxy/carbonyl, epoxy/hydroxyl, reaction of epoxy with a Lewis acid or Lewis base, polyisocyanate/hydroxy, amino resin/hydroxy moieties, free radical reactions or polyacrylate, cationic polymerization of epoxy resins and vinyl ether and condensation of silanol. Examples of unsaturated resins include polyester resins made by the reaction of one or more diacids or anhydrides with one or more diols. Such resins are commonly supplied as a mixture with a reactive monomer such as styrene or vinyltoluene and are often referred to as orthophthalic resins and isophthalic resins. Further examples include resins using dicyclopentadiene (DCPD) as a co-reactant in the polyester chain. Further examples also include the reaction products of bisphenol A diglycidyl ether with unsaturated carboxylic acids such as methacrylic acid, subsequently supplied as a solution in styrene, commonly referred to as vinyl ester resins. Polymers with hydroxy functionality (such as polyols) are widely used in thermosetting systems to crosslink with amino resins or polyisocyanates. The polyols include acrylic polyols, alkyd polyols, polyester polyols, polyether polyols, and polyurethane polyols. Illustrative amino resins include melamine formaldehyde resins, benzoguanamine formaldehyde resins, urea formaldehyde resins and glycoluril formaldehyde resins. Polyisocyanates are resins with two or more isocyanate groups, including both monomeric aliphatic diisocyanates, monomeric aromatic diisocyanates and their polymers. Illustrative aliphatic diisocyanates include hexamethylene diisocyanate, isophorone diisocyanate and hydrogenated diphenylmethane diisocyanate. Illustrative aromatic isocyanates include toluene diisocyanates and biphenylmethane diisocyanates.

In certain embodiments, the coupling agent is present in an amount of from 0.5 to 5 (such as from 1 to 5, from 1.5 to 5, from 2 to 5, from 2.5 to 5, from 3 to 5, from 3.5 to 5, from 4 to 5, from 4.5 to 5, from 0.5 to 4.5, from 1 to 4.5, from 1.5 to 4.5, from 2 to 4.5, from 2.5 to 4.5, from 3 to 4.5, from 3.5 to 4.5, from 4 to 4.5, from 0.5 to 4, from 1 to 4, from 1.5 to 4, from 2 to 4, from 2.5 to 4, from 3 to 4, from 3.5 to 4, from 0.5 to 3.5, from 1 to 3.5, from 1.5 to 3.5, from 2 to 3.5, from 2.5 to 3.5, from 3 to 3.5, from 0.5 to 3, from 1 to 3, from 1.5 to 3, from 2 to 3, from 2.5 to 3, from 0.5 to 2.5, from 1 to 2.5, from 1.5 to 2.5, from 2 to 2.5, from 0.5 to 2, from 1 to 2, from 1.5 to 2, from 0.5 to 1.5, from 1 to 1.5, or from 0.5 to 1) weight percent, based on the total weight of the thermoset composition.

In certain embodiments, monomeric unit a according to formula I may be derived from radically polymerizing an aromatic or aliphatic vinyl monomer, such as an aromatic vinyl, such as styrene and/or substituted styrene, for example 4-acetoxystyrene, 4-benzhydrylstyrene, 4-benzyl oxy-3-methoxy styrene, 2-bromostyrene, 3-bromostyrene, 4-bromostyrene, 4-tert-butoxystyrene, 4-tert-butyl styrene, 2-chlorostyrene, 3-chlorostyrene, 4-chlorostyrene, 2,6-dichlorostyrene, 2,6-difluorostyrene, 3,4-dimethoxy styrene, 2,4-dimethylstyrene, 2,5-dimethyl styrene, N,N-dimethylvinylbenzylamine, 4-ethoxystyrene, 2-fluorostyrene, 3-fluorostyrene, 4-fluorostyrene, 3-methylstyrene, 4-methylstyrene, 3-nitrostyrene, 2,3,4,5,6-pentafluorostyrene, 3-(trifluoromethyl)styrene, 4-(trifluoromethyl)styrene, 2,4,6-trimethylstyrene, 4-vinylanisole, 3-vinylbenzoic acid, 4-vinylbenzoic acid, 4-vinylbenzyl chloride, 4-vinylbiphenyl, 2-vinylnaphthalene. In certain embodiments, R² may be a C₁ to C₂₀ alkyl group. In certain embodiments, R² may be a C₆ to C₁₀ aryl group.

In certain embodiments, monomeric unit b according to formula I may be derived from radically polymerizing a vinyl anhydride monomer, such as maleic anhydride or itaconic anhydride.

In certain embodiments, monomeric unit c according to formula I may be derived from radically polymerizing a vinyl anhydride monomer (such as maleic anhydride or itaconic anhydride) reacted with an amino-functional vinyl monomer, such as vinyl ether or (meth)acrylate (such as 2-(2-propen-1-yloxy)-Ethanamine or 2-Aminoethyl methacrylate hydrochloride).

In certain embodiments, monomeric unit d according to formula I may be derived from radically polymerizing a vinyl anhydride monomer (such as maleic anhydride or itaconic anhydride) reacted with a hydroxy-functional vinyl ether or (meth)acrylate (such as 2-allyoxyethanol, ally alcohol, 1,4-butanediol vinyl ether, di(ethylene glycol) vinyl ether, poly(ethylene glycol) vinyl ether, diethylene glycol monoallyl ether, 3-allyoxy-1,2-propanediol, 2-hydroxyethyl acrylate, 2-hydroxyethyl methacrylate, 4-hydoxybutyl acrylate, 6-hydroxyhexyl methacrylate, poly(ethylene glycol) methacrylate, poly(ethylene glycol) acrylate, poly(propylene glycol) methacrylate, poly(propylene glycol) acrylate or 2,3-dihydroxypropyl methacrylate).

In certain embodiments, monomeric unit e according to formula I may be derived from radically polymerizing a vinyl anhydride monomer (such as maleic anhydride or itaconic anhydride) reacted with POL¹ via an amine linkage. In certain embodiments, POL¹ may be a hydroxy-functional polyether chain, for example polyethylene glycol methyl ether or polypropylene glycol methyl ether. In certain embodiments, POL¹ may be an amino functional polyether, for example polyether amines available from Huntsman under the trade names Surfonamine® L100, L207, L300, B100, and/or B200.

In certain embodiments, monomeric unit f according to formula I may be derived from radically polymerizing a vinyl anhydride monomer (such as maleic anhydride or itaconic anhydride) reacted with POL² via an amine or hydroxyl linkage. In certain embodiments, POL² may be a hydroxy-functional polyether chain, for example polyethylene glycol methyl ether or polypropylene glycol methyl ether. In certain embodiments, POL² may be an amino functional polyether, for example polyether amines available from Huntsman under the trade names Surfonamine® L100, L207, L300, B100, and/or B200.

In certain embodiments each of Z¹ and/or Z² is independently oxygen, where a mono-hydroxyl-functional polyester has been reacted on to the anhydride monomer. This mono-hydroxy-functional polyester can be synthesized by any method known to those skilled in the art by polymerization of lactones and/or lactides and/or hydroxycarboxylic acids, optionally in the presence of mono alcohols to initiate the polyester chain extension. Useful alcohols include, but are not limited to, methanol, ethanol, n-propanol, n-butanol, neopentyl alcohol, n-hexanol, n-heptanol, n-octanol, n-decanol, n-dodecanol, n-tetradecanol, n-hexadecanol, oleyl alcohol, n-octadecanol, isopropanol, isobutanol, tert-butanol, 2-ethylbutanol, 2-ethylhexanol, 3 heptanol, 3,5,5-trimethylhexanol, 3,7-dimethyloctanol, cyclohexanol, cyclopentanol, cyclopentanemethanol, cyclohexylmethanol, 4-cyclohexyl-1-butanol, 4-ethylcyclohexanol, cycloheptanol, phenol, ortho-cresol, 2-ethylphenol, 2-propylphenol, 4-ethylphenol, octyl phenol, nonylphenol, dodecylphenol, di- and tri-styrylphenols, benzyl alcohol, 2-phenylethanol, 1-naphthol, 2-naphthol, 2-phenylphenol, 4-phenylphenol, polyisobutylene phenol, sec-phenethyl alcohol, 4-ethylbenzyl alcohol, 4-butylbenzyl alcohol, 2-naphthalenemethanol, 3-phenyl-1-propanol, 4-phenyl-1-butanol, cinnamyl alcohol and 4-propoxyphenol, 2-dimethylaminoethanol, 2-diethylaminoethanol, 2-dibutylaminoethanol, 2-propen-1-ol, allyl alcohol, 4-penten-1-ol, 2-hexen-1-ol, 3-nonen-1-ol, 7-dodecen-1-ol, saturated linear alcohols commercially available under the trade name Unilin™ (available from Baker Hughes) and saturated branched alcohols such as the “Guerbet” alcohols which are commercially available under the trade name Isofol (available from Sasol GmbH) including mixtures thereof. Specific examples of commercially available Guerbet alcohols are Isofol 12, 14T, 16, 18T, 18E, 20, 24, 28, 32, 32T and 36.

In certain embodiments, the coupling agent comprises at least 90 (such as at least 91, at least 92, at least 93, at least 94, at least 95, at least 96, at least 97, at least 98, or at least 99) percent by weight monomeric units a, b, c, d, e, and f, according to formula I, based on the total weight of the coupling agent. In certain embodiments, the coupling agent comprises from 90 to 100 (such as from 91 to 100, from 92 to 100, from 93 to 100, from 94 to 100, from 95 to 100, from 96 to 100, from 97 to 100, from 98 to 100, from 99 to 100, from 90 to 99, from 91 to 99, from 92 to 99, from 93 to 99, from 94 to 99, from 95 to 99, from 96 to 99, from 97 to 99, from 98 to 99, from 90 to 98, from 91 to 98, from 92 to 98, from 93 to 98, from 94 to 98, from 95 to 98, from 96 to 98, from 97 to 98, from 90 to 97, from 91 to 97, from 92 to 97, from 93 to 97, from 94 to 97, from 95 to 97, from 96 to 97, from 90 to 96, from 91 to 96, from 92 to 96, from 93 to 96, from 94 to 96, from 95 to 96, from 90 to 95, from 91 to 95, from 92 to 95, from 93 to 95, from 94 to 95, from 90 to 94, from 91 to 94, from 92 to 94, from 93 to 94, from 90 to 93, from 91 to 93, from 92 to 93, from 90 to 92, from 91 to 92, or from 90 to 91) percent by weight monomeric units a, b, c, d, e, and f, according to formula I, based on the total weight of the coupling agent.

In certain embodiments, the coupling agent comprises at least 70 (such as at least 75, at least 80, at least 85, at least 90, or at least 95) percent by weight monomeric units a and b, according to formula I, based on the total weight of the coupling agent. In certain embodiments, the coupling agent comprises from 70 to 95 (such as from 75 to 95, from 80 to 95, from 85 to 95, from 90 to 95, from 70 to 90, from 75 to 90, from 80 to 90, from 85 to 90, from 70 to 85, from 75 to 85, from 80 to 85, from 70 to 80, from 75 to 80, or from 70 to 75) percent by weight monomeric units a and b, according to formula I, based on the total weight of the coupling agent.

In certain embodiments, the coupling agent comprises no more than 30 (such as no more than 25, no more than 20, no more than 15, no more than 10, or no more than 5) percent by weight monomeric units c, d, e, and f, according to formula I, based on the total weight of the coupling agent. In certain embodiments, the coupling agent comprises from 5 to 30 (such as from 10 to 30, from 15 to 30, from 20 to 30, from 25 to 30, from 5 to 25, from 10 to 25, from 15 to 25, from 20 to 25, from 5 to 20, from 10 to 20, from 15 to 20, from 5 to 15, from 10 to 15, or from 5 to 10) percent by weight monomeric units c, d, e, and f, according to formula I, based on the total weight of the coupling agent.

In certain embodiments, the coupling agent comprises at least 50 (such as at least 55, at least 60, at least 65, at least 70, at least 75, or at least 80) percent by weight monomeric units a, according to formula I, based on the total weight of the coupling agent. In certain embodiments, the coupling agent comprises from 50 to 80 (such as from 55 to 80, from 60 to 80, from 65 to 80, from 70 to 80, from 75 to 80, from 50 to 75, from 55 to 75, from 60 to 75, from 65 to 75, from 70 to 75, from 50 to 70, from 55 to 70, from 60 to 70, from 65 to 70, from 50 to 65, from 55 to 65, from 60 to 65, from 50 to 60, from 55 to 60, or from 50 to 55) percent by weight monomeric units a, according to formula I, based on the total weight of the coupling agent.

In certain embodiments, the coupling agent comprises no more than 40 (such as no more than 35, no more than 30, no more than 25, no more than 20, no more than 15, no more than 10, or no more than 5) percent by weight monomeric units b, according to formula I, based on the total weight of the coupling agent. In certain embodiments, the coupling agent comprises from 5 to 40 (such as from 10 to 40, from 15 to 40, from 20 to 40, from 25 to 40, from 30 to 40, from 35 to 40, from 5 to 35, from 10 to 35, from 15 to 35, from 20 to 35, from 25 to 35, from 30 to 35, from 5 to 30, from 10 to 30, from 15 to 30, from 20 to 30, from 25 to 30, from 5 to 25, from 10 to 25, from 15 to 25, from 20 to 25, from 5 to 20, from 10 to 20, from 15 to 20, from 5 to 15, from 10 to 15, or from 5 to 10) percent by weight monomeric units b, according to formula I, based on the total weight of the coupling agent.

In certain embodiments, a is an integer from 5 to 500, such as from 10 to 500, from 15 to 500, from 20 to 500, from 25 to 500, from 50 to 500, from 75 to 500, from 100 to 500, from 150 to 500, from 200 to 500, from 250 to 500, from 300 to 500, from 350 to 500, from 400 to 500, from 450 to 500, from 1 to 450, from 5 to 450, from 10 to 450, from 15 to 450, from 20 to 450, from 25 to 450, from 50 to 450, from 75 to 450, from 100 to 450, from 150 to 450, from 200 to 450, from 250 to 450, from 300 to 450, from 350 to 450, from 400 to 450, from 1 to 400, from 5 to 400, from 10 to 400, from 15 to 400, from 20 to 400, from 25 to 400, from 50 to 400, from 75 to 400, from 100 to 400, from 150 to 400, from 200 to 400, from 250 to 400, from 300 to 400, from 350 to 400, from 1 to 250, from 5 to 350, from 10 to 350, from 15 to 350, from 20 to 350, from 25 to 350, from 50 to 350, from 75 to 350, from 100 to 350, from 150 to 350, from 200 to 350, from 250 to 350, from 300 to 350, from 1 to 300, from 5 to 300, from 10 to 300, from 15 to 300, from 20 to 300, from 25 to 300, from 50 to 300, from 75 to 300, from 100 to 300, from 150 to 300, from 200 to 300, from 250 to 300, from 1 to 250, from 5 to 250, from 10 to 250, from 15 to 250, from 20 to 250, from 25 to 250, from 50 to 250, from 75 to 250, from 100 to 250, from 150 to 250, from 200 to 250, from 1 to 200, from 5 to 200, from 10 to 200, from 15 to 200, from 20 to 200, from 25 to 200, from 50 to 200, from 75 to 200, from 100 to 200, from 150 to 200, from 1 to 150, from 5 to 150, from 10 to 150, from 15 to 150, from 20 to 150, from 25 to 150, from 50 to 150, from 75 to 150, from 100 to 150, from 1 to 100, from 5 to 100, from 10 to 100, from 15 to 100, from 20 to 100, from 25 to 100, from 50 to 100, from 75 to 100, from 1 to 75, from 5 to 75, from 10 to 75, from 15 to 75, from 20 to 75, from 25 to 75, from 50 to 75, from 1 to 50, from 5 to 50, from 10 to 50, from 15 to 50, from 20 to 50, from 25 to 50, from 1 to 25, from 5 to 25, from 10 to 25, from 15 to 25, from 20 to 25, from 1 to 20, from 5 to 20, from 10 to 20, from 15 to 20, from 1 to 15, from 5 to 15, from 10 to 15, from 1 to 10, from 5 to 10, or from 1 to 5.

In certain embodiments, b is an integer from 5 to 500, such as from 10 to 500, from 15 to 500, from 20 to 500, from 25 to 500, from 50 to 500, from 75 to 500, from 100 to 500, from 150 to 500, from 200 to 500, from 250 to 500, from 300 to 500, from 350 to 500, from 400 to 500, from 450 to 500, from 1 to 450, from 5 to 450, from 10 to 450, from 15 to 450, from 20 to 450, from 25 to 450, from 50 to 450, from 75 to 450, from 100 to 450, from 150 to 450, from 200 to 450, from 250 to 450, from 300 to 450, from 350 to 450, from 400 to 450, from 1 to 400, from 5 to 400, from 10 to 400, from 15 to 400, from 20 to 400, from 25 to 400, from 50 to 400, from 75 to 400, from 100 to 400, from 150 to 400, from 200 to 400, from 250 to 400, from 300 to 400, from 350 to 400, from 1 to 250, from 5 to 350, from 10 to 350, from 15 to 350, from 20 to 350, from 25 to 350, from 50 to 350, from 75 to 350, from 100 to 350, from 150 to 350, from 200 to 350, from 250 to 350, from 300 to 350, from 1 to 300, from 5 to 300, from 10 to 300, from 15 to 300, from 20 to 300, from 25 to 300, from 50 to 300, from 75 to 300, from 100 to 300, from 150 to 300, from 200 to 300, from 250 to 300, from 1 to 250, from 5 to 250, from 10 to 250, from 15 to 250, from 20 to 250, from 25 to 250, from 50 to 250, from 75 to 250, from 100 to 250, from 150 to 250, from 200 to 250, from 1 to 200, from 5 to 200, from 10 to 200, from 15 to 200, from 20 to 200, from 25 to 200, from 50 to 200, from 75 to 200, from 100 to 200, from 150 to 200, from 1 to 150, from 5 to 150, from 10 to 150, from 15 to 150, from 20 to 150, from 25 to 150, from 50 to 150, from 75 to 150, from 100 to 150, from 1 to 100, from 5 to 100, from 10 to 100, from 15 to 100, from 20 to 100, from 25 to 100, from 50 to 100, from 75 to 100, from 1 to 75, from 5 to 75, from 10 to 75, from 15 to 75, from 20 to 75, from 25 to 75, from 50 to 75, from 1 to 50, from 5 to 50, from 10 to 50, from 15 to 50, from 20 to 50, from 25 to 50, from 1 to 25, from 5 to 25, from 10 to 25, from 15 to 25, from 20 to 25, from 1 to 20, from 5 to 20, from 10 to 20, from 15 to 20, from 1 to 15, from 5 to 15, from 10 to 15, from 1 to 10, from 5 to 10, or from 1 to 5.

In certain embodiments, the ratio of a to b is from 1:1 to 10:1, from 1:1 to 9:1, from 1:1 to 8:1, from 1:1 to 7:1, from 1:1 to 6:1, from 1:1 to 5:1, from 1:1 to 4:1, from 1:1 to 3:1, from 1:1 to 2:1, from 2:1 to 10:1, from 2:1 to 9:1, from 2:1 to 8:1, from 2:1 to 7:1, from 2:1 to 6:1, from 2:1 to 5:1, from 2:1 to 4:1, from 2:1 to 3:1, from 3:1 to 10:1, from 3:1 to 9:1, from 3:1 to 8:1, from 3:1 to 7:1, from 3:1 to 6:1, from 3:1 to 5:1, from 3:1 to 4:1, from 4:1 to 10:1, from 4:1 to 9:1, from 4:1 to 8:1, from 4:1 to 7:1, from 4:1 to 6:1, from 4:1 to 5:1, from 5:1 to 10:1, from 5:1 to 9:1, from 5:1 to 8:1, from 5:1 to 7:1, from 5:1 to 6:1, from 6:1 to 10:1, from 6:1 to 9:1, from 6:1 to 8:1, from 6:1 to 7:1, from 7:1 to 10:1, from 7:1 to 9:1, from 7:1 to 8:1, from 8:1 to 10:1, from 8:1 to 9:1, or from 9:1 to 10:1.

In certain embodiments, c is an integer from 1 to 100, from 5 to 100, from 10 to 100, from 15 to 100, from 20 to 100, from 30 to 100, from 40 to 100, from 50 to 100, from 60 to 100, from 70 to 100, from 80 to 100, from 90 to 100, from 1 to 90, from 5 to 90, from 10 to 90, from 15 to 90, from 20 to 90, from 30 to 90, from 40 to 90, from 50 to 90, from 60 to 90, from 70 to 90, from 80 to 90, from 1 to 80, from 5 to 80, from 10 to 80, from 15 to 80, from 20 to 80, from 30 to 80, from 40 to 80, from 50 to 80, from 60 to 80, from 70 to 80, from 1 to 70, from 5 to 70, from 10 to 70, from 15 to 70, from 20 to 70, from 30 to 70, from 40 to 70, from 50 to 70, from 60 to 70, from 1 to 60, from 5 to 60, from 10 to 60, from 15 to 60, from 20 to 60, from 30 to 60, from 40 to 60, from 50 to 60, from 1 to 50, from 5 to 50, from 10 to 50, from 15 to 50, from 20 to 50, from 30 to 50, from 40 to 50, from 1 to 40, from 5 to 40, from 10 to 40, from 15 to 40, from 20 to 40, from 30 to 40, from 1 to 30, from 5 to 30, from 10 to 30, from 15 to 30, from 20 to 30, from 1 to 20, from 5 to 20, from 10 to 20, from 15 to 20, from 1 to 15, from 5 to 15, from 10 to 15, from 1 to 10, from 5 to 10, or from 1 to 5.

In certain embodiments, d is an integer from 1 to 100, from 5 to 100, from 10 to 100, from 15 to 100, from 20 to 100, from 30 to 100, from 40 to 100, from 50 to 100, from 60 to 100, from 70 to 100, from 80 to 100, from 90 to 100, from 1 to 90, from 5 to 90, from 10 to 90, from 15 to 90, from 20 to 90, from 30 to 90, from 40 to 90, from 50 to 90, from 60 to 90, from 70 to 90, from 80 to 90, from 1 to 80, from 5 to 80, from 10 to 80, from 15 to 80, from 20 to 80, from 30 to 80, from 40 to 80, from 50 to 80, from 60 to 80, from 70 to 80, from 1 to 70, from 5 to 70, from 10 to 70, from 15 to 70, from 20 to 70, from 30 to 70, from 40 to 70, from 50 to 70, from 60 to 70, from 1 to 60, from 5 to 60, from 10 to 60, from 15 to 60, from 20 to 60, from 30 to 60, from 40 to 60, from 50 to 60, from 1 to 50, from 5 to 50, from 10 to 50, from 15 to 50, from 20 to 50, from 30 to 50, from 40 to 50, from 1 to 40, from 5 to 40, from 10 to 40, from 15 to 40, from 20 to 40, from 30 to 40, from 1 to 30, from 5 to 30, from 10 to 30, from 15 to 30, from 20 to 30, from 1 to 20, from 5 to 20, from 10 to 20, from 15 to 20, from 1 to 15, from 5 to 15, from 10 to 15, from 1 to 10, from 5 to 10, or from 1 to 5.

In certain embodiments, e is an integer from 1 to 100, from 5 to 100, from 10 to 100, from 15 to 100, from 20 to 100, from 30 to 100, from 40 to 100, from 50 to 100, from 60 to 100, from 70 to 100, from 80 to 100, from 90 to 100, from 1 to 90, from 5 to 90, from 10 to 90, from 15 to 90, from 20 to 90, from 30 to 90, from 40 to 90, from 50 to 90, from 60 to 90, from 70 to 90, from 80 to 90, from 1 to 80, from 5 to 80, from 10 to 80, from 15 to 80, from 20 to 80, from 30 to 80, from 40 to 80, from 50 to 80, from 60 to 80, from 70 to 80, from 1 to 70, from 5 to 70, from 10 to 70, from 15 to 70, from 20 to 70, from 30 to 70, from 40 to 70, from 50 to 70, from 60 to 70, from 1 to 60, from 5 to 60, from 10 to 60, from 15 to 60, from 20 to 60, from 30 to 60, from 40 to 60, from 50 to 60, from 1 to 50, from 5 to 50, from 10 to 50, from 15 to 50, from 20 to 50, from 30 to 50, from 40 to 50, from 1 to 40, from 5 to 40, from 10 to 40, from 15 to 40, from 20 to 40, from 30 to 40, from 1 to 30, from 5 to 30, from 10 to 30, from 15 to 30, from 20 to 30, from 1 to 20, from 5 to 20, from 10 to 20, from 15 to 20, from 1 to 15, from 5 to 15, from 10 to 15, from 1 to 10, from 5 to 10, or from 1 to 5.

In certain embodiments, f is an integer from 1 to 100, from 5 to 100, from 10 to 100, from 15 to 100, from 20 to 100, from 30 to 100, from 40 to 100, from 50 to 100, from 60 to 100, from 70 to 100, from 80 to 100, from 90 to 100, from 1 to 90, from 5 to 90, from 10 to 90, from 15 to 90, from 20 to 90, from 30 to 90, from 40 to 90, from 50 to 90, from 60 to 90, from 70 to 90, from 80 to 90, from 1 to 80, from 5 to 80, from 10 to 80, from 15 to 80, from 20 to 80, from 30 to 80, from 40 to 80, from 50 to 80, from 60 to 80, from 70 to 80, from 1 to 70, from 5 to 70, from 10 to 70, from 15 to 70, from 20 to 70, from 30 to 70, from 40 to 70, from 50 to 70, from 60 to 70, from 1 to 60, from 5 to 60, from 10 to 60, from 15 to 60, from 20 to 60, from 30 to 60, from 40 to 60, from 50 to 60, from 1 to 50, from 5 to 50, from 10 to 50, from 15 to 50, from 20 to 50, from 30 to 50, from 40 to 50, from 1 to 40, from 5 to 40, from 10 to 40, from 15 to 40, from 20 to 40, from 30 to 40, from 1 to 30, from 5 to 30, from 10 to 30, from 15 to 30, from 20 to 30, from 1 to 20, from 5 to 20, from 10 to 20, from 15 to 20, from 1 to 15, from 5 to 15, from 10 to 15, from 1 to 10, from 5 to 10, or from 1 to 5.

In certain embodiments, the coupling agent comprises up to 10 (such as up to 9, up to 8, up to 7, up to 6, up to 5, up to 4, up to 3, up to 2, or up to 1) percent by weight other monomeric units, different from monomeric units a, b, c, d, e, and f according to formula I. In certain embodiments, the coupling agent comprises from greater than 0 to 10 (such as from greater than 0 to 9, from greater than 0 to 7, from greater than 0 to 6, from greater than 0 to 5, from greater than 0 to 4, from greater than 0 to 3, from greater than 0 to 2, from greater than 0 to 1, from 1 to 10, from 1 to 9, from 1 to 8, from 1 to 7, from 1 to 6, from 1 to 5, from 1 to 4, from 1 to 3, from 1 to 2, from 2 to 10, from 2 to 9, from 2 to 8, from 2 to 7, from 2 to 6, from 2 to 5, from 2 to 4, from 2 to 3, from 3 to 10, from 3 to 9, from 3 to 8, from 3 to 7, from 3 to 6, from 3 to 5, from 3 to 4, from 4 to 10, from 4 to 9, from 4 to 8, from 4 to 7, from 4 to 6, from 4 to 5, from 5 to 10, from 5 to 9, from 5 to 8, from 5 to 7, from 5 to 6, from 6 to 10, from 6 to 9, from 6 to 8, from 6 to 7, from 7 to 10, from 7 to 9, from 7 to 8, from 8 to 10, from 8 to 9, or from 9 to 10) percent by weight other monomeric units, different from monomeric units a, b, c, d, e, and f according to formula I. In certain embodiments, the coupling agents is substantially free of, or free of, other monomeric units, different from monomeric units a, b, c, d, e, and f according to formula I. In this context, “substantially free of” means that the other monomeric units are not intentionally added or created, but that they may be present by inclusion of impurities in reactants and/or by creation of unintended reaction products. In certain embodiments, the other monomeric units are vinyl-functional monomeric units.

Also provided is a method of manufacturing the thermoset composition(s) described herein, comprising dissolving the coupling agent into the thermoset resin with or without solvent, then adding the particulate solid and other additives. The other additives may include at least one of dispersants, defoamers, internal release agents, accelerators, etc.

Also provided is a method of manufacturing the thermoset composition(s) described herein, comprising dispersing the coupling agent as a dry solid into the thermosetting resin, then adding the particulate solid and other additives. The other additives may include at least one of dispersants, defoamers, internal release agents, accelerators, etc.

Also provided is a method of imparting high/improved tensile strength to the thermoset composition(s) described herein, comprising dispersing the particulate solid into the thermosetting resin in the presence of the coupling agent.

Also provided is a method of imparting fire retardancy to the thermoset composition(s) described herein, comprising dispersing the particulate solid (which imparts fire retardancy) into the thermosetting resin in the presence of the coupling agent.

Also provided is a method of light-weighting the thermoset composition(s) described herein, comprising dispersing a hollow particle (glass sphere) and filler (as the particulate solid) into the thermosetting resin in the presence of the coupling agent.

Also provided is a method of manufacturing the thermoset composition(s) described herein, comprising treating the particulate solid with the coupling agent to create a treated particulate solid, then adding the treated particulate solid to the thermosetting resin. For example, fibrous material may be pre-treated with a sizing agent that also acts as the coupling agent.

The subject matter disclosed herein may be better understood with reference to the following examples, which are set forth merely to further illustrate the subject matter disclosed herein. The illustrative examples should not be construed as limiting the subject matter in any manner.

Example 1: Polystyrene-co-polymaleic anhydride copolymer (2:1 molar ratio styrene:maleic anhydride, 20 parts) was dissolved in ethyl acetate (79.69 parts) at 70° C. under nitrogen. Polyether amine (56.90 parts) was added and the reactants were stirred for 2 hours until consumption of amine was confirmed by titration. The temperature was then increased to 100° C. for 3 hours to remove solvent. Nitrogen blanket was removed, 2-hydroxyethyl methacrylate (2.55 parts) and 2,6-Di-tert-butyl-4-methylphenol (0.24 parts) were added and the reactants were heated to 120° C. under air for 5 hours. An amber liquid was obtained.

Example 1 was incorporated into a dispersion containing calcium carbonate and recycled carbon fibre in an unsaturated polyester resin (Palapreg® P17-02 from AOC AG). The formulation included a peroxide cure catalyst (tert-butylperoxy benzoate ex Sigma Aldrich). Examples 2 and 3 included the number of parts of each component as shown in Table 1, below. The tensile strength of each of Examples 2 and 3 were measured by an Instron tensile strength tester and reported in Table 1.

TABLE 1

| | Ex. 2 | Ex. 3 |
|---|---|---|
| Unsaturated polyester resin | 50 | 50 |
| Calcium carbonate | 125 | 125 |
| Carbon fibre | 15 | 15 |
| Cure catalyst | 0.8 | 0.8 |
| Example 1 | | 2.6 |
| Tensile strength (MPa) | 23.9 | 36.7 |

Example 4: Poly(isobutylene-alt-maleic anhydride) (average M_{w}=6000, 15.34 parts) was suspended in water (93 parts) under nitrogen at 70° C. Polyether amine (surfonamine® L207 ex Huntsman, 69.07 parts) was added and the reactants were stirred for 1 hour. The temperature was increased >100° C. to remove water over 4 hours. Nitrogen blanket was removed, 2-hydroxyethyl methacrylate (4.45 parts) and 2,6-Di-tert-butyl-4-methylphenol (0.29 parts) were added and the reactants were heated at 95° C. for 8 hours. An amber liquid was obtained with molecular weight determined by GPC in tetrahydrofuran spiked with 1% acetic acid against polystyrene standards Mn=2623, Mw=11212.

The following testing was carried out to determine the suitability of the examples described herein for various applications where fiber- and/or filler-reinforced thermoset plastic may be used. These formulation examples, with noted illustrative, typical applications, are not intended to be limiting but are intended to highlight the multiple potential complex resin-filler/fibre interfaces present within composite materials where reactive coupling agents of the type described herein may be beneficial. ‘Coupling’ of the filler/fibre surface to the bulk resin at the molecular level during cure is known to give rise to beneficial mechanical property improvements in the macroscopic composite parts or articles formed that contain these interfaces.

The benefits observed in the measurements of such mechanical properties and the modes chosen to investigate such improvements are highly dependent on the isotropy of the composite material, which is a result of the filler and fibre alignment within the resin matrix relative to the forces subjected. The stresses and strains generated during different mechanical testing modes are thus transferred by differing degrees at the resin-filler/fibre interfaces present, depending on the relative orientations of these interfaces to the force applied in a particular testing mode. Hence, depending on the formulation; filler/fibre alignment and positioning; forming and manufacturing technique employed to produce the composite article being tested; benefits of coupling agents of the present subject matter may or may not be observed in a range of standardized mechanical tests. Suitable tests (or modifications thereof) for assessing mechanical improvements in composite articles are numerous but are summarized non-exhaustively in ASTM D4762-18; it is contemplated that any of these tests may be used to ascertain the effectiveness of the present subject matter in particular materials and/or for particular uses of the resulting materials. Any such test listed may thus be useful in demonstrating the benefits exemplified here when used appropriately by someone skilled in the art. The benefits observed here, in the more fundamental and dynamic test used and described, thus may translate into benefits in an appropriately chosen higher order, static or dynamic, mechanical test.

Testing on Examples 5 and 6 was undertaken with milled fibres in place of other fibre forms to decrease anisotropy in the composite materials formed during the testing exemplified, limiting the complexity of measurement that may arise from anisotropy with other fibre forms. The mechanical benefits of ‘coupling’ at the resin-filler/fibre interfaces are more clearly deciphered from other strengthening and stiffening effects in this fundamental test type and in the comparison of moduli measured. The benefits observed will thus translate into benefits observable with more standardized and mode specific testing, appropriate for more anisotropic materials derived from higher order fibre/filler forms and arrangements, where the testing mode is chosen appropriately to probe coupling at the interface in question, as listed, non-exhaustively in ASTM D4762-18.

Other fundamental testing approaches likely to show similar translatable observations to other mechanical modes may focus on observing benefits at a single isolated interface of interest, orientating this interface into the desired plane relative to the stresses and strains of the mechanical mode used and measuring the modulus or stress at failure of this interface in isolation. Test methods of this type, that measure the interfacial shear strength (IFSS), may also be useful in demonstrating the benefit of coupling agents of the present subject matter, an example of such a test which can be applied to the study of thermosets is described in Interface strength in glass fibre-polypropylene measured using the fibre pull-out and microbond methods. L.Yang & J. L. Thomason, 2010, Composites Part A: Applied Science and Manufacturing, Vol 41, issue 9 p 1077-1083.

Forming and curing of the composite article may need to take place in a range of conditions dependent on the manufacturing technique employed and the chemical makeup of the resin formulation. Typically, as well as curing agents, initiators or catalysts, other chemical additives such as promoters, accelerators or inhibitors can be used within a formulation, chosen to suit the resin chemistry and enable curing of the thermoset under the desired conditions of handling, forming and manufacturing of a composite article. Identifying if an additional additive, such as the coupling agents of the present subject matter, effect the curing kinetics of the overall composite formulation, is important to understand suitability of these agents for applications and formulations of interest. Thus the ‘through cure’ testing employed in the following examples allows the comparison of curing times with and without the presence of the exemplified additives of the present subject matter. Ideally, little or no changes to the curing kinetics are desirable.

In general, the formulations described were tested in a single frequency, oscillatory ‘through cure’ experiment of the type described by Tianhong T. Chen et al. (Characterising thermoset curing using rheology; SAMPE Conference proceedings 2019, Society for the advancement of Material and Process Engineering). Using additional guidance from ASTM D4065 20 Standard Practice for Plastics: Dynamic Mechanical Properties: Determination and report Procedures.

A DHR-1 rheometer (TAInstruments) fitted with 25 mm disposable aluminium parallel plates was used in conjunction with an ETC accessory. All test involved subjecting a sample of uncured formulation of set volume, determined by the initial geometry gap; to torsional oscillations at a frequency of 1 Hz through a temperature profile that cured the formulation of interest and was applicable to the application of interest. Active controls were used in both strain and axial force during the test to enable monitoring of the curing process whilst staying within the linear viscoelastic limit of the material. Axial force adjustment was used throughout the runs actively controlling axial force to 0.0±0.1 N in compression mode and auto strain adjustment was used as described in the referenced procedure. However, certain parameters were adjusted in the test for different formulation to better suit the likely manufacturing conditions employed for each example set and these are described in detail for each instance as follows, after the formulation descriptions for the examples detailed.

Measurements derived from individual experiments were calculated from analysis carried out in the instrument supported Trios software. The onset ‘gel’ temperature of cure was calculated from the storage modulus cure with respect to temperature (d(Log(G′))/dT). The storage modulus in the isothermal post cure plateau was calculated by correcting for differences in the gap between experiments for different samples through regression correlation in this region (^{b}), to adhere to the principles of equivalent sample dimensions dictated in ASTM D4065 but applied in this experimental context of torsion between parallel plates. The measurement derived from the through cure experiments were used to screen the exampled coupling agent for their suitability in the exemplified formulation and inferred applications.

Examples 8 was incorporated into a dispersions of aluminium trihydroxide (Martinal™ OL104 ex Huber) and milled glass fibre (1320K ex Owens Corning) in a liquid epoxy resin (Epikote™ 827 ex Hexion) by mixing for a total of time of 6-10 mins on a planetary centrifugal mixer at 2,000 rpm allowing the sample to cool to room temperature every 2 mins. The formulations include a dicyandiamide curing agent (Amicure® CG1400F ex Evonik) and an imidazole curing accelerator (Curezol® 2MZ-Azine ex Evonik). Table 2 details the % by weight of each component in the tested formulations for examples 5 and 6.

TABLE 2

| | Ex. 5 | Ex. 6 |
|---|---|---|
| Example 4 | | 0.8 |
| Epikote 827 | 37.3 | 37.0 |
| Amicure CG1400F | 3.9 | 3.9 |
| Curezol 2MZ Azine | 2.6 | 2.5 |
| ATH (Martinal OL104) | 37.5 | 37.2 |
| Milled glass fibre (1320K) | 18.7 | 18.6 |

Examples 9 and 10 are representative of a fireretardant formulation typically used for GFRP compression moulded electrical fittings.

For example 5 and 6, a temperature ramp from 25-135° C. at 5° C./min was used. Holding at 135° C. for 10 mins to continue measurement post sample cure. Initial gap size was 1000 μm with a trim offset of 50 m, giving a minimum sample volume at test start of 0.49087 mL. A gap temperature compensation—expansion coefficient of 2.7398 m/° C., compliance of 2.02 mrad/N·m, stress constant 325949 Pa/N·m, strain constant 12.5 1/rad and normal stress constant 4074.37 Pa/N. However, geometry inertia and friction were calibrated for each run. Variable run parameters for examples 5 and 6 are summarised as follows in table 3.

TABLE 3

| | | Geometry Inertia | Friction |
|---|---|---|---|
| | Additive | (μN · m · s²) | (μN · m/(rad/s)) |
| Ex. 5 | blank | 2.34254 | 0.278571 |
| Ex. 6 | Ex. 4 | 2.39741 | 0.275064 |

The measurement of examples 5 and 6 are detailed in table 4.

TABLE 4

| | | Storage Modulus | Onset ‘gel’ |
|---|---|---|---|
| | Additive | Plateau (Mpa) | temp (° C.) |
| Ex. 5 | blank | 14.5 | 125.5 |
| Ex. 6 | Ex. 4 | 17.2 | 127.8 |

Except in the Examples, or where otherwise explicitly indicated or required by context, all numerical quantities in this description specifying amounts of materials, reaction conditions, molecular weights, number of carbon atoms, and the like, are to be understood as modified by the word “about”. As used herein, the term “about” means that a value of a given quantity is within ±20% of the stated value. In other embodiments, the value is within ±15% of the stated value. In other embodiments, the value is within ±10% of the stated value. In other embodiments, the value is within ±5% of the stated value. In other embodiments, the value is within ±2.5% of the stated value. In other embodiments, the value is within ±1% of the stated value. In other embodiments, the value is within a range of the explicitly-described value which would be understood by those of ordinary skill, based on the disclosures provided herein, to perform substantially similarly to compositions including the literal amounts described herein.

It is to be understood that the upper and lower amount, range, and ratio limits set forth herein may be independently combined, and that any amount within a disclosed range is contemplated to provide a minimum or maximum of a narrower range in alternative embodiments (with the proviso, of course, that the minimum amount of a range must be lower than the maximum amount of the same range). Similarly, the ranges and amounts for each element of the subject matter disclosed herein may be used together with ranges or amounts for any of the other elements.

While certain representative embodiments and details have been shown for the purpose of illustrating the subject matter disclosed herein, it will be apparent to those skilled in this art that various changes and modifications may be made therein without departing from the scope of the subject matter. In this regard, the scope of the invention is to be limited only by the following claims.

1. A thermoset composition comprising a dispersion of a particulate solid into a thermosetting resin in the presence of a coupling agent comprising monomeric units a, b, c, d, e, and f according to formula I: 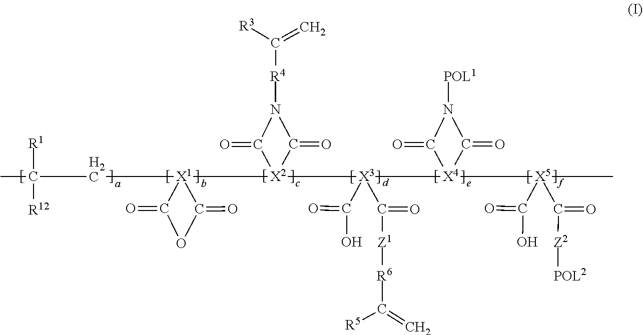
wherein, independently for each molecule of the polymer:
R¹ is H or CH₃;
R² is H, a C₁ to C₂₀ alkyl group, a C₆ to C₁₀ aryl group, a C₇ to C₁₄ alkaryl group, or a C₄ to C₆ cycloalkyl group;
X¹ is 2 or 3 carbon atoms, wherein if X¹ is 3 carbon atoms, one of the carbon atoms is not included in the polymer backbone;
X² is 2 or 3 carbon atoms, wherein if X² is 3 carbon atoms, one of the carbon atoms is not included in the polymer backbone;
R³ is H or CH₃;
R⁴ is a C₁ to C₂₀ alkyl group, —C—O—R⁷—, or —(C═O)—O—C—R⁷—, wherein R⁷ is a C₁ to C₂₀ alkyl group;
X³ is 2 or 3 carbon atoms, wherein if X³ is 3 carbon atoms, one of the carbon atoms is not included in the polymer backbone;
R⁵ is H or CH₃;
R⁶ is a C₁ to C₂₀ alkyl group, —C—O—R⁸—, or —(C═O)—O—C—R⁸—, wherein R⁸ is a C₁ to C₂₀ alkyl group;
Z¹ is NH or O;
X⁴ is 2 or 3 carbon atoms, wherein if X⁴ is 3 carbon atoms, one of the carbon atoms is not included in the polymer backbone;
POL¹ is a polymer comprising at least one of a polyether or a polyester, wherein the polymer has a theoretical-number-average molecular weight of from 200 to 3,000;
X⁵ is 2 or 3 carbon atoms, wherein if X⁵ is 3 carbon atoms, one of the carbon atoms is not included in the polymer backbone;
POL² is a polymer comprising at least one of a polyether or a polyester, wherein the polymer has a theoretical-number-average molecular weight of from 200 to 3,000;
Z² is NH or O;
a is an integer from 1 to 500;
b is an integer from 1 to 500;
c is 0, or an integer from 1 to 100;
d is 0, or an integer from 1 to 100;
e is 0, or an integer from 1 to 100; and
f is 0 or an integer from 1 to 100;
wherein: if c is 0, d is at least 1; if d is 0, c is at least 1; if e is 0, f is at least 1; and if f is 0, e is at least 1.

2. The thermoset composition of claim 1, wherein the particulate solid is present in an amount of from 20 to 80 weight percent, based on the total weight of the thermoset composition.

3. (canceled)

4. (canceled)

5. (canceled)

6. (canceled)

7. The thermoset composition of claim 1, wherein the thermosetting resin is present in an amount of from 80 to 20 weight percent, based on the total weight of the thermoset composition.

8. The thermoset composition of claim 1, wherein the thermosetting resin comprises an epoxide resin, an unsaturated polyester resin, a vinyl ester resin, a polyurethane resin, or a phenolic resin.

9. The thermoset composition of claim 1, wherein the coupling agent is present in an amount of from 0.5 to 5 weight percent, based on the total weight of the thermoset composition.

10. The thermoset composition of claim 1, wherein the coupling agent comprises at least 90 percent by weight monomeric units a, b, c, d, e, and f, according to formula I, based on the total weight of the coupling agent.

11. The thermoset composition of claim 1, wherein the coupling agent comprises at least 70 percent by weight monomeric units a and b, according to formula I, based on the total weight of the coupling agent.

12. The thermoset composition of claim 1, wherein the coupling agent comprises no more than 30 percent by weight monomeric units c, d, e, and f, according to formula I, based on the total weight of the coupling agent.

13. The thermoset composition of claim 1, wherein the coupling agent comprises at least 50 percent by weight monomeric units a, according to formula I, based on the total weight of the coupling agent.

14. The thermoset composition of claim 1, wherein the coupling agent comprises no more than 40 percent by weight monomeric units b, according to formula I, based on the total weight of the coupling agent.

15. The thermoset composition of claim 1, wherein a is an integer from 5 to 500.

16. The thermoset composition of claim 1, wherein a is an integer from 20 to 50.

17. The thermoset composition of claim 1, wherein b is an integer from 2 to 100.

18. The thermoset composition of claim 1, wherein b is an integer from 3 to 12.

19. The thermoset composition of claim 1, wherein the ratio of a to b is from 1:1 to 10:1.

20. The thermoset composition of claim 1, wherein c is an integer from 3 to 12.

21. The thermoset composition of claim 1, wherein d is an integer from 3 to 12.

22. The thermoset composition of claim 1, wherein e is an integer from 4 to 16.

23. The thermoset composition of claim 1, wherein f is an integer from 4 to 16.

24. The thermoset composition of claim 1, wherein the coupling agent comprises up to 10 percent by weight other monomeric units, different from monomeric units a, b, c, d, e, and f, according to formula I.
